(19) United States
(12) Patent Application Publication
(10) Pub. No.: US 2022/0297801 A1
(43) Pub. Date: Sep. 22, 2022

(54) TOWING WINCH SYSTEM AND A METHOD TO CARRY OUT A TOWING OPERATION, IN PARTICULAR AN ESCORT OPERATION FOR ASSISTING A VESSEL IN PASSING A WATER PASSAGE

(71) Applicant: TUGPINS B.V., SCHIEDAM (NL)

(72) Inventor: Johannes Bernardus Gerardus KREISCHER, SCHIEDAM (NL)

(21) Appl. No.: 17/608,939

(22) PCT Filed: May 8, 2020
(86) PCT No.: PCT/EP2020/062883

§ 371 Date: Nov. 4, 2021

(30) Foreign Application Priority Data
May 10, 2019 (NL) 2023108

(51) Int. Cl. B63B 21/16; B63B 21/56; B66D 1/50; B66D 1/14; B66D 5/14

(52) U.S. Cl. CPC B63B 21/16; B63B 21/56; B66D 1/505; B66D 1/14; B66D 5/14

(57) ABSTRACT

Towing winch system 1 for controlling a render and recovery of a towline during a towing operation. The towing winch system has a control unit 6 for controlling a drive 4 and a brake 5 for respectively driving and braking the winding drum. The drive 4 comprises a plurality of brushless alternating current motors 40 which each engages in one stage by a motor gear wheel 71 to a gear wheel 70 mounted to the winding drum 3. The brake 5 comprises a plurality of brake calipers 51 which each are engageable to a brake disc 50 mounted to the winding drum 3. The drivetrain of the plurality of brushless AC motors 40, one stage gear 7 and the plurality of brake calipers 51 form a powerful and robust structure to operate the towing winch system 1 under severe conditions which may occur in a towing operation.

The present invention relates to a towing winch system for controlling a hauling in, also called a recovery, and paying out, also called a render, of a towline in between a floating object and a towboat during a towing operation, in particular during an escort operation. Such a towing winch system may also be called a render and recovery winch system. Further, the invention relates to a method for towing a floating object by a towboat. In particular, the invention relates to an escort method for assisting a vessel in passing a water passage.

A towing operation is a typical operation which has its own dynamic behaviour. In comparison with other marine operations like mooring and anchoring, the dynamic behaviour of a towing operation is considerably different. During a towing operation, high running speeds of a relatively long towline are at hand. The towline is running in changing directions when rendering and recovering the towline. Additionally, the towline may get exposed to shock loads when a towline is slacking.

A towing winch system on board of a towboat has to cope with this dynamic behaviour.

The towing winch system to carry out a towing operation may have structural similarities with a mooring winch system but a towing winch system typically has to perform under more severe conditions. A winding drum of the towing winch system has to run at high rotational speeds and is subjected to quick rotational directional changes to haul in or pay out a towline. In general, it appears that a mooring winch system is not optimally suitable to carry out a towing operation.

EP2.385.011B1 discloses an example of a mooring winch which satisfies to carry out a mooring operation, but which is not satisfying in carrying out a towing operation. When a ship is moored alongside a wharf or a quay in a harbour, mooring ropes anchoring the ship must be properly tensioned so as to hold the ship in an appropriate position. The mooring ropes should be maintained in correct tension to prevent hazardous situations which might arise for the reason that the mooring ropes will become subjected to greater forces due to the tendency of the ship to move relative to the wharf or quay. Relative movements are caused by variations of the level of water surface due to tidal changes and variations of the displacement of the ship due to cargo loading and/or unloading. The ship might be rocked or rolled by waves or wind to induce a fluctuating tension in the mooring ropes. A too great tension in the rope might cause the rope to break.

The disclosed mooring winch has a computer program for controlling a mooring rope tension. The tension of the rope is either measured or computed on the basis of the other measured variables. It is possible to measure the speed of the motor, the torque of the motor or torque of the winding drum or the tension of the rope.

The disclosed mooring winch comprises a winding drum driven by an alternating current motor in which the winding drum is provided with a brake to hold the winding drum. A frequency conversion unit is arranged to supply electrical power to the alternating current motor. A control unit is arranged to control the frequency conversion unit on the basis of an indicator for tension of the mooring rope. The control unit is arranged to compute a torque estimate based on stator currents of the AC motor. This torque estimate is used as an indicator for the tension of the mooring rope. Hence, the mooring rope tension is being kept within allowed limits by keeping the torque estimate within allowed limits.

The control unit is arranged to set a reference value. The reference value determines a rotational speed of the AC motor at a predetermined value. First, the brake holding the winding drum is released and then the AC motor is driven in one direction for a predetermined time interval to define a first value of the torque of the motor. The AC motor is driven in an opposite direction for the predetermined interval to define a second value of the torque of the motor to compute a torque estimate using the first and the second value of the torque.

A problem to this known mooring winch is that this winch is not suitable to be used in a towing operation. As said above, a dynamic behaviour of a towline in a towing operation differs significantly from a dynamic behaviour in a mooring operation which is situated alongside a wharf or a quay in a harbour. Typically, in a mooring operation, line speeds may increase up to 20 m/minute, while in a towing operation rendered speeds may reach 80 m/min with a line force of 110 tonnes and recovery speeds are up to 40 m/min with a line force of 30 tonnes. Tidal fluctuations to be compensated in a mooring operation along a quay are relatively slow and have a moderate magnitude in comparison with the towing operation which is carried out in open water with more severe heaving. In addition, generally, longer towlines are used in a towing operation which may be exposed to shock loads due to a slack of the towline. In a towing operation, tension forces may occur more abrupt when the towline comes under tension. As such a mooring winch is not suitable to be used in these heavy circumstances, a towing winch system is desired which has a capacity to carry out a towing operation.

EP2.830.985 discloses a system for powering a winch which is designed to operate under more severe conditions. To perform under more severe conditions, a hybrid solution is disclosed. An improved gear box is disclosed in order to improve the dynamic properties of the winch system during operation. The gear box is connected to both a hydraulic and an electric drive. The gear box has an output shaft which engages with the winch winding drum. One of the sides of the winding drum is provided with cut teeth along a periphery of the winding drum side. The teeth project radially and are aligned in parallel with an axis of rotation of the winding drum. The teeth mesh together with teeth of a gear wheel which is rigidly fixed at the end of the output shaft of the gearbox. At an opposite side of the gearbox, a central input rotatable shaft is driven by the hydraulic motor. The central input shaft is connected to a sun wheel of the gearbox. Three planet wheels are provided around the sun wheel and connected to the gear wheel at the end of the output shaft of the gearbox. An inner and outer rotatable annulus are arranged around the planet wheels. The outer annulus is in engagement with a gear wheel on a shaft of a first and second electric motor.

The hydraulic motor is provided to be operated only in case of an overload. The hydraulic motor is a safety measure opening up when the tension in the wire approaches a predetermined set value. The hydraulic motor is connected all the time, but starts to operate only when the load of the line becomes too high.

However, the planetary gearbox increases the complexity in a mechanical sense which is undesired. Problems to the gearbox may arise when this winch is subjected to high rotational speeds which may occur during a towing operation. The hydraulic motor as a safety measure is disadvantageous, because it increases the complexity of the winch system. A hybrid control for both controlling the electric motors and the hydraulic motor is necessary. In addition, it is suggested to include a cooling circuit in the hydraulic system as a simple and economical solution, but this is also unsatisfying as it even further increase complexity of the winch system.

EP2.363.371 discloses a vessel having a towing winch which is designed to carry out a towing operation. The winch has a frame and a cable drum which has a drum shaft accommodated in said frame. A hydraulic drive is provided to drive said shaft which comprises the drive motor and a coupling. The coupling is arranged between the drive motor and the drum shaft. The coupling is a hydraulic coupling which is controlled to reduce a torque transfer between an input and output shaft. A load-measuring sensor which determines a force exerted on the cable drum is connected to a control unit to control a power/torque to be transmitted by the coupling. The hydraulic coupling is necessary to maintain a taut connection between a vessel to be towed and a towing vessel while, on the other hand, preventing the winch structure from being overloaded, as such an overload can completely destroy the driving winch motor.

A problem to this winch is that the coupling may prevent an overload of the winch but decoupling implies that at least for a while a running towline may be out of control. A further drawback of the disclosed winch structure is that its structure is rather complex. The hydraulic coupling includes a lot of components. Many parts are susceptible to wear and have their own fail factor. The large amount of components reduces a reliability of the winch system. Further, the footprint of the winch system is relatively large which is not desired on board of a tow boat which normally has narrow build-in spaces.

WO2016/204726 also discloses a winch system which is used in an escort operation. In the escort operation, the escort tug is tethered to the stern of a large ship or tanker. In an emergency, if a tanker ship has a loss of power or rudder failure, an escort tug will be ordered to go to the port or starboard side of the tanker and will be directed to go into the indirect mode or power indirect mode. The disclosed winch system has a staple-torque rotative winch, also called an auto position winch, which is mounted to the deck of the escort tug. This rotative arrangement may reduce side forces acting on the winch during the escort operation. Herewith, this auto position winch is configured to mitigate the dynamic effects during the escort operation.

Although such a rotatable winch as disclosed may contribute in mitigating the effects of a dynamic behaviour in a towing operation, it is still desired to provide a further improved towing winch system which has a performance to cope with a dynamic behaviour during a towing operation.

The general object of the present invention is to at least partially eliminate the above mentioned drawbacks and/or to provide a usable alternative. More specific, it is an object of the invention to provide a towing winch system which complies to mechanical requirements related to a dynamic behaviour of a towing operation in which high torques and shock loads are combined with high running speeds and rotational reversals of a winding drum. It is a challenge to present a towing winch system with a robust structure having a capacity to perform under severe conditions during a towing operation.

According to the invention, this object is achieved by a towing winch system according to claim 1.

The towing winch system is configured to control a towline in between a vessel and a tug during a towing operation, in particular an escort operation. The towing winch system is configured to control a hauling in, also called a recovery, and paying out, also called a render, of the towline. The towing winch system may also be called a render and recovery winch system.

The towing winch system comprises a framework for supporting components of the towing winch system.

The towing winch system comprises a winding drum for winding and unwinding the towline. The winding drum is rotatable supported by the framework. The winding drum has a drum forming a winding space in between a first and second winding drum flange for enclosing the towline.

The towing winch system comprises a drive for driving the winding drum for hauling in the towline. The drive is connected by a gear to the winding drum. The gear is a one-stage gear for reducing a revolving speed of a motor in a one step reduction to a lower revolving speed of the drum. The one-stage gear comprises a gear wheel which is mounted to the winding drum. The drive directly engages with the gear wheel. Preferably, the one-stage gear has a gear ratio of at least 15:1, more preferably at least 20:1. Herewith, the gear is configured for connecting the drive with a one-step reduction to the winding drum.

In a towing operation, the one-stage gear is advantageous in that the one-stage gear has a high efficiency in transferring driving forces from the drive to the winding drum to anticipate on high torques produced by the towline. The one-stage gear is further advantageous in the towing operation in which it is required to carry out rotational reversals of the winding drum to change from a recovery to a rendering of the towline and vice versa. The one-stage gear is beneficial in counteracting occurring shock loads during these reversals. In addition, a relative low mass inertia of the one-stage gear allows the winding drum of the towing winch system to run at high speeds. In comparison with a multiple stage gearbox, the one-stage gear according to the invention means a considerable simplification of the structure of the towing winch system which contributes to its compactness and a small footprint of the towing winch system on-board of a towboat. This configuration of the gear may be further beneficial in a periodical servicing of the towing winch system. Demounting and replacement of wear parts can be carried out with less operational impact.

The towing winch system further comprises a brake which is operatively connected to the winding drum for holding or paying out the towline. The brake comprises at least one brake disc.

The towing winch system comprises a control unit for controlling the drive and the brake. The control unit is operatively connected with the drive to power the drive to accelerate the winding drum for hauling in the towline. The control unit is also operatively connected with the brake to engage with the winding drum to hold the winding drum in a standstill position or to brake the winding drum when unwinding the towline to control a rotational speed of the drum.

The drive and the brake are controlled by the control unit based on an input signal indicative of a torque exerted by the towline on the winding drum.

The towing winch system according to the invention provides an improvement in that the drive comprises a plurality of motors and in that the brake further comprises a plurality of brake calipers. Each brake caliper is provided with a pair of brake pads for engaging with the at least one brake disc. The control unit is programmed to separately control each individual motor and brake caliper.

The control of the brake calipers for holding or braking the winding drum is advantageously a reliable and expedient way to control a towline tension during the towing operation. In a towing operation, a towline tension may increase by driving forces of the towboat. Sudden variations, e.g. due to heave motion, may cause shock loads which can advantageously be mitigated by allowing the winding drum to slip in the brake calipers.

The configuration of the towing winch system including a plurality of motors and brake calipers is further beneficial in that a basic design can be used to cover a broad range of applications. An amount of motors and brake calipers of the basic design can be adapted to a particular situation when for example a holding force is required of 20 metric tonnes or in another situation the amount can be increased when a holding force of 150 metric tonnes is required. Herewith, the basic design can be used for a configuration of a large towing winch system for an ocean towing boat, but also for a smaller towing winch system for an inland towing boat, also called a tugboat.

In a towing operation, the presence of multiple motors and brake calipers allow a flexible control of the winch system to anticipate on many possible occurring circumstances. The control of the winch system can be optimally tuned to the situation. In severe conditions, all available motors and brake calipers can be activated, while in a more moderate condition only a part of the motors and brake calipers may be involved in controlling the winch system. The active motors and brake calipers can be used in their optimal operational range to respectively provide a desired driving or braking torque.

In controlling the towing winch system, only one or more motors of a total amount of motors can be driven which may be beneficial in a heat management of the drive. Advantageously, the towing winch system may be embodied without an active motor cooling.

Another advantage of the presence of the plurality of motors and brake calipers may be that an operation may still continue despite of an occurring need for service to anyone of the items. An amount of motors or brake calipers may be redundant for a certain operation. The control unit may exclude one or more items from the operation, wherein the remaining items can take over the function of the excluded item. Herewith, the reliability of the winch system in operation can be greatly increased in comparison with a single motor drive or a single brake. For a proper operation and continuation, the towing winch system according to the invention is less dependent on a proper working of all its components.

In a first aspect of the invention, the towing winch system according to the invention further provides an improvement in that the drive comprises a plurality of brushless alternating current motors. Such a brushless alternating current motor is also called a permanent magnet synchronous motor (PMSM). The motor has a motor rotor which is provided with an amount of permanent magnets. A motor stator is provided with an equal amount of field coils to excite the motor rotor. Each motor has a motor housing and a motor output shaft. A motor gear wheel is connected to the motor output shaft which engages to the gear wheel which is mounted to the winding drum. The motor gear wheel and the gear wheel connected to the winding drum together form the one-stage gear.

The plurality of brushless AC motors provide an advantage in that these motors may provide a high motor torque which can be delivered over a wide range of revolving speeds. A torque can be delivered at low revolving speeds which is beneficial in accelerating the winding drum from a standstill, but the high torque remains also available at high revolving speeds for hauling in or paying out the towline. The brushless AC motors enable the towing winch system to deliver a torque which remains available along substantially the whole operational reach of revolving speeds of the towing winch system. In comparison with an asynchronous induction motor, the brushless AC motor provides a nominal torque which is substantially constant over an operational range of revolving speed, while the asynchronous induction motor may suffer a significant drop in its nominal torque performance above 15% of a lower speed limit of its revolving speed range.

Seen the winch of EP2830985 above, the plurality of brushless AC motors may make the hydraulic motor redundant to control the towing winch system in a towing operation. In an embodiment of the towing winch system according to the invention, the control of the drive is fully electric. The electric drive may suffice and no hydraulic motor is necessary for driving the winding drum. Advantageously, the towing winch system according to the invention is environmental friendly.

The brushless AC motor is further beneficial in that the drive control can be improved by a data signal output from this motor to the control unit. A data output from each motor during operation can be used to improve the control of the winding drum.

Advantageously, due to the presence of the brushless AC motors, the one-stage gear of the towing winch system can be embodied without a clutch for decoupling the drive. The towing winch system may remain free from a clutch. The one stage gear including the gear wheel and engaged by the motor gear wheels at the circumference of the gear wheel may be sufficient robust to withstand the high pulling forces occurring at high speed winding drum revolutions. The one-stage gear of the towing winch system may perform under all conditions without a necessity of a decoupling of the drive to release from the winding drum. Hence, it is an advantage that the towing winch system according to the invention can be embodied without a clutch or other coupling element as a safety measure to prevent a failure of the drive or gear.

It may be further beneficial that the brushless AC motors may allow rendering a towline at high speeds without getting overheated. The towing winch system may be embodied without a cooling circuit.

In an embodiment of the towing winch system according to the invention, the brushless AC motor has a motor rotor provided with at least 8 permanent magnets. Preferably, the at least 8 permanent magnets contain neodymium material, more in particular, the at least 8 permanent magnets comprise neodymium-iron-boron material. The neodymium material is beneficial to make the plurality of motors together sufficient powerful to accelerate the winding drum to high rotational speeds when hauling in a towline. Advantageously, such a brushless AC motor contributes in complying to mechanical requirements for a towing winch system which is suitable to carry out an escort operation in severe conditions. The at least 8 permanent magnets are further beneficial in providing a quick response on a changing situation. In keeping a tow line under tension, the winding drum has to rotate in opposite directions to render and to recover the towline when the tow boat is heaving on the waves. The at least 8 permanent magnets, and more preferably at least 16 permanent magnets of the motor rotor contribute in a quick response to keep the towline tension under control and to prevent slacking of the towline.

In an embodiment of the towing winch system according to the invention, the winding drum comprises a drum which is rotatable supported by a horizontally arranged drum shaft. The drum shaft is supported by the framework. The horizontally arranged drum shaft is beneficial in a towing operation, in which a towline may be directed upwards under a large angle in connection with a floating object. Preferably, the drum shaft is arranged stationary. Bearings are mounted to the drum. The bearings are supported by the drum shaft to allow the drum to rotate. Advantageously, the stationary arranged drum shaft allows a quick release and mounting of the winding drum for periodical maintenance.

In an embodiment of the towing winch system according to the invention, the gear wheel is mounted to the drum of the winding drum. Preferably, a winding drum flange is connected by the gear to the drive. The gear wheel may be directly mounted to the first or second winding drum flange of the drum. Instead of driving the winding drum via a drum shaft, the winding drum is preferably driven by directly engaging the drum which is beneficial in transferring driving forces. Such a short drivetrain from the drive via the gear directly to the drum provides a robust structure.

In a second aspect of the invention, the gear wheel has a toothed outer circumferential surface to be engaged by each motor gear wheel. Preferably, the plurality of motor gear wheels engaging the gear wheel are positioned at a lower half region of the gear wheel, such that the winding drum together with the gear wheel can be lifted away from the motor gear wheels without demounting the motors from the framework.

According the second aspect of the invention, a towing winch system for controlling a render and recovery of a towline in between a vessel and a towboat during a towing operation, in particular an escort operation, which towing winch system comprises:
a framework for supporting winch components;
a winding drum for winding and unwinding the towline in which the winding drum is rotatable supported by the framework, in which the winding drum has a drum forming a winding space in between a first and second winding drum flange for enclosing the towline;
a drive connected by a one-stage gear to the winding drum for rotating the winding drum for hauling in the towline, wherein the one-stage gear comprises a gear wheel mounted to the winding drum;
a brake connected to the winding drum for braking the winding drum for holding or paying out the towline;
a control unit for controlling the drive and the brake based on an input signal indicative of a torque exerted by the towline on the winding drum;
   wherein the drive comprises a plurality of motors, wherein each motor has a motor housing and a motor output shaft provided with a motor gear wheel which engages to the gear wheel mounted to the winding drum,
   wherein the brake comprises at least one brake disc and a plurality of brake calipers in which each brake caliper is provided with a pair of brake pads for engaging the at least one brake disc, wherein each motor gear wheel engages to an outer toothed circumferential surface of the gear wheel, wherein the plurality of motor gear wheels and/or the plurality of brake calipers are all positioned in a lower half region of the gear wheel, such that the winding drum, brake disc and/or gear wheel can be lifted from the framework without demounting the motors and/or brake calipers.

A motor may be a hydraulic motor or an electric motor, in particular a brushless AC motor.

Preferably, the drum is rotatable supported by a horizontally arranged drum shaft, wherein the winding drum shaft is supported by the framework and preferably arranged stationary.

The gear wheel is preferably mounted to one of the drum flanges of the drum.

In an embodiment of the towing winch system according to the invention, the winding drum is positioned in between the drive and the brake. The first winding drum flange is connected to the drive and the second winding drum flange is connected to the brake disc of the brake. Tension forces introduced by the towline and acting on the drum are directly transferred via the brake disc to the brake calipers. Advantageously, such a short pathway for deducting exerted forces is effective in counteracting the tension forces by the towing winch system.

In a third aspect of the towing winch system according to the invention, the framework comprises a main frame for supporting the winding drum. The mainframe may be box-shaped. Preferably, the mainframe has a left and right side plate provided with a shaft support for supporting a drum shaft. Further, the mainframe may have a bottom plate, front plate and a back plate which together with the side plates form an inner space for housing winch components. Preferably, the framework further has a base plate which is pivotally connected to an upper portion of the mainframe. Herewith, the upper portion of the mainframe is pivotable about a pivot axis with respect to the base plate to allow a load measurement. The pivot axis extends in a horizontal direction in parallel with the base plate. At least one load sensor may be mounted in between the base plate and the mainframe at a distance from the pivot axis for measuring an occurring load on the winding drum during a towing operation. A single load sensor may be provided, but advantageously, a second load sensor may be provided to obtain multidirectional load data. The at least one load sensor provides load data to the control unit for controlling the drive and the brake.

In an embodiment of the towing winch system according to the invention, the framework comprises a mainframe and a brake frame. The brake frame is releasably connectable to the mainframe. A separate brake frame may be beneficial in servicing the towing winch system. The brake frame is arranged to support the plurality of brake calipers. The brake frame has a mounting surface for each brake caliper. In particular, the brake frame is L-shaped to dispose the plurality of brake calipers along a circumference of the brake disc. Preferably, the brake frame is U-shaped. In the U-shaped brake frame, the plurality of brake calipers are disposed at an inner mounting surface to engage the brake disc received in the U-shaped opening of the brake frame. The U-shaped brake frame may be formed by an assembly of two separate L-shaped brake frames positioned opposite and facing each other.

In an embodiment of the towing winch system according to the invention, the framework, in particular the brake frame, comprises a load sensor for measuring a force induced by a brake caliper. The load sensor may be a load cell. The load sensor may be positioned in a recess of the brake frame. The load sensor is operatively connected to the control unit. The load sensor generates a load sensor signal as an input to the control unit. Based on the load sensor signal, the control unit generates an output signal to the drive and brake of the towing winch system.

According to the third aspect of the invention, a towing winch system for controlling a render and recovery of a towline in between a vessel and a towboat during a towing operation, in particular an escort operation, which towing winch system comprises:
a framework for supporting winch components;
a winding drum for winding and unwinding the towline in which the winding drum is rotatable supported by the framework, in which the winding drum has a drum forming a winding space in between a first and second winding drum flange for enclosing the towline;
a drive connected by a one-stage gear to the winding drum for rotating the winding drum for hauling in the towline, wherein the one-stage gear comprises a gear wheel mounted to the winding drum;
a brake connected to the winding drum for braking the winding drum for holding or paying out the towline;
a control unit for controlling the drive and the brake based on an input signal indicative of a torque exerted by the towline on the winding drum;
   wherein the drive comprises a plurality of motors, wherein each motor has a motor housing and a motor output shaft provided with a motor gear wheel which engages to the gear wheel mounted to the winding drum,
   wherein the brake comprises at least one brake disc and a plurality of brake calipers in which each brake caliper is provided with a pair of brake pads for engaging the at least one brake disc,
   wherein the framework, in particular a brake frame, comprises at least one load sensor for measuring a force inducted by a brake caliper.

Preferably, the framework comprises a mainframe including a base plate, wherein an upper portion of the mainframe is pivotally connected to the base plate about a pivot axis, wherein the at least one load sensor, in particular two load sensors, is positioned in between the upper portion and the base plate at a distance from the pivot axis. In an embodiment of the towing winch system according to the invention, at least one of the drum flanges has a coding for indicating an amount of towline available in the winding space of the drum. Preferably, the coding is a colour coding for visually indicating a predetermined winding zone of the winding space. In particular, the colour coding has a coloured ring shaped area on an inside of a drum flange to indicate the winding zone. Preferably, the ring shaped area is a yellow ring shaped area. The colour coding preferably contains at least two distinguishing colours, e.g. black and yellow, to visually indicate to a skipper/towline operator when a towline is running out the winding zone. In a particular embodiment, the coding may comprise a sensor for detecting the available amount of towline in the winding space of the drum. Preferably, the sensor is an optical sensor for detecting a colour change of the colour coding.

Further, the invention relates to a towboat comprising a towing winch system according to the invention.

Further, the invention relates to an assembly of the towboat and a floating object interconnected by a towline and a towing winch system according to the invention.

According to a next aspect of the invention, the invention relates to a towing winch system having a winding drum with a drum in which the drum has a first and second drum flange to form a winding space for enclosing a towline, wherein the winding space has a predetermined winding zone and wherein a coding is provided to indicate the winding zone.

Further, the invention relates to a method for towing a floating object, in particular a vessel like a tanker or a ship, by a towboat. The method it is also called a towing method or in particular an escorting method for escorting a vessel.

In the method according to the invention, a use is made of a towing winch system according to the invention. In a step of the method, the towing winch system according to the invention is provided. The towing method comprises a step of hauling in the towline, a step of paying out towline and a step of measuring and occurring torque caused by the towline on a winding drum of the towing winch system. The towing method comprises a step of controlling the drive of the towing winch system to rotate the winding drum for holding in the towline and a step of controlling a brake of the towing winch system to brake the winding drum for holding or paying out towline.

In an embodiment of the method according to the invention, only a portion of a plurality of brake calipers and/or motors is activated to respectively brake or drive the winding drum. The towing winch system may be configured to have an overcapacity for a particular towing operation which is beneficial to increase a lifespan and operational continuation of the towing winch system.

The invention will be explained in more detail with reference to the appended drawings. The drawings show a practical embodiment according to the invention, which may not be interpreted as limiting the scope of the invention. Specific features may also be considered apart from the shown embodiment and may be taken into account in a broader context as a delimiting feature, not only for the shown embodiment but as a common feature for all embodiments falling within the scope of the appended claims, in which:

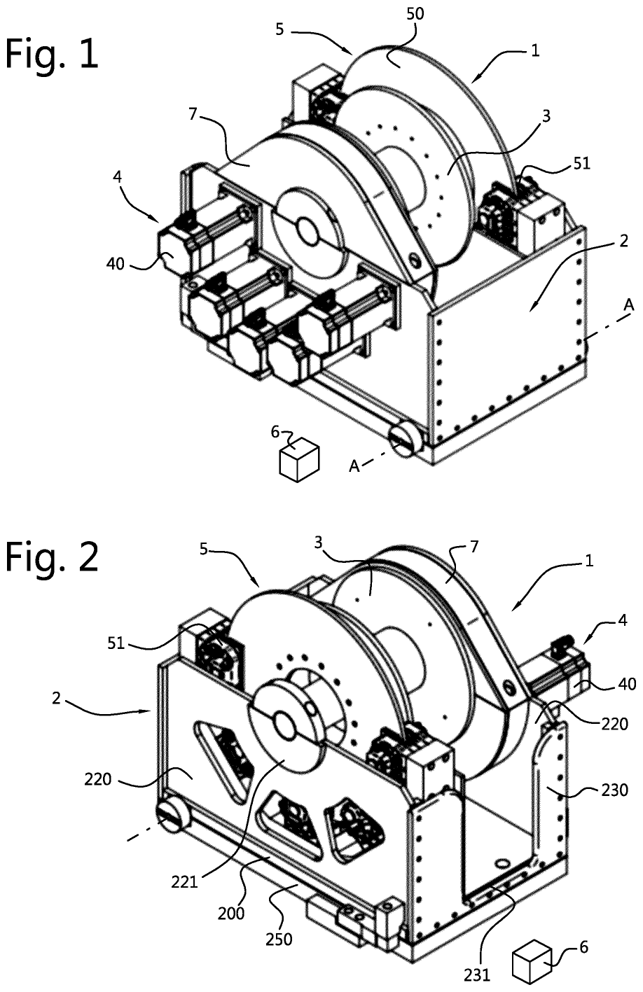

FIGS. 1 and 2 show perspective views of a towing winch system according to the invention;

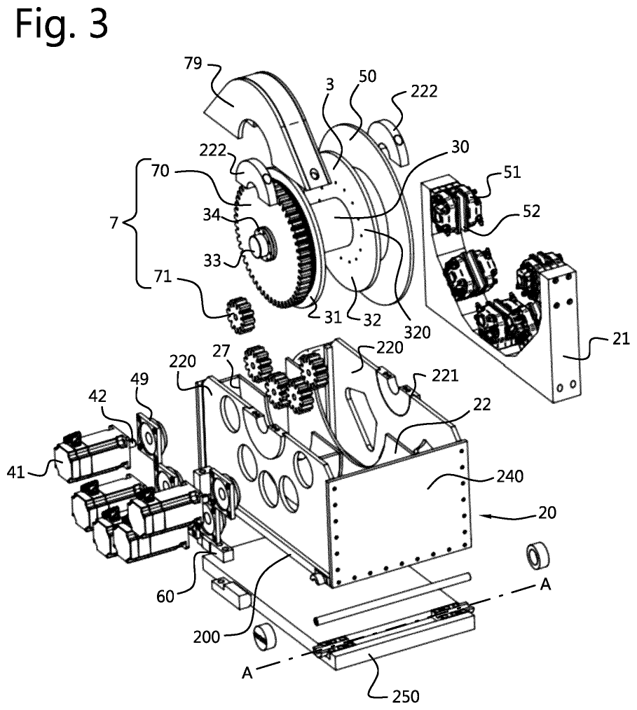

FIG. 3 shows the towing winch system of FIG. 1 in an exploded view;

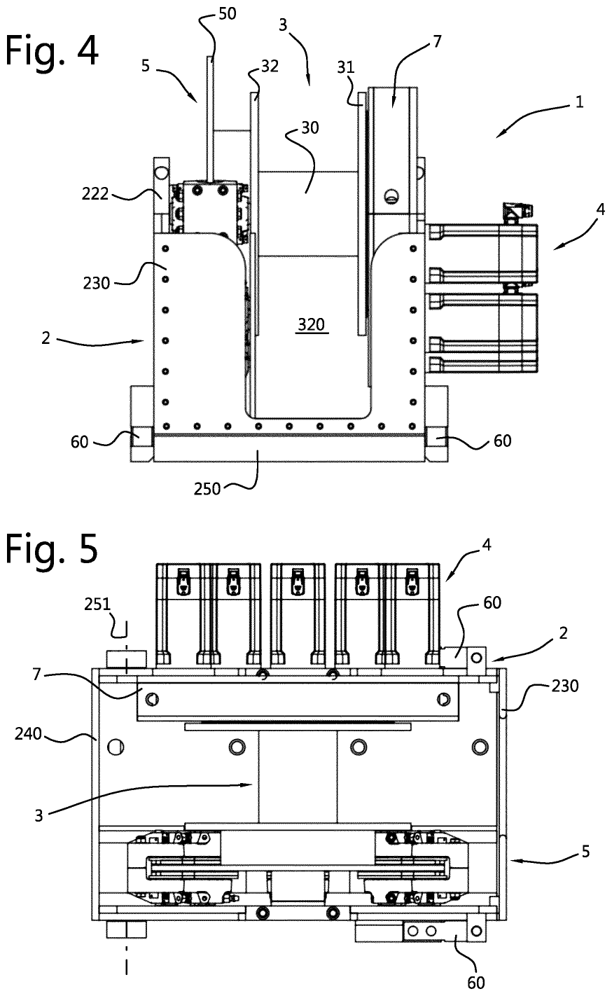

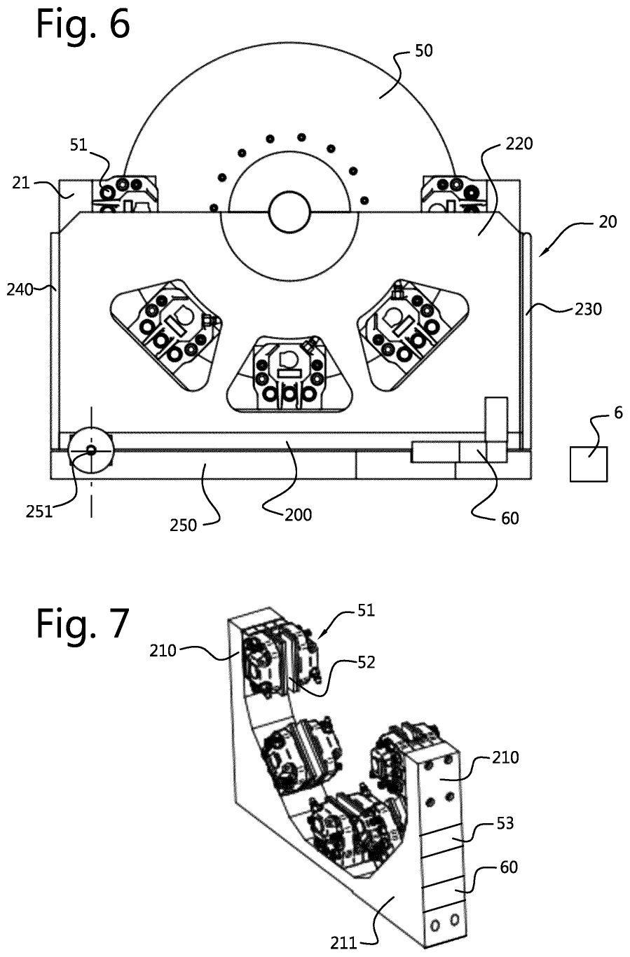

FIG. 4-6 show orthogonal views of the towing winch system of FIGS. 1-3; and

FIG. 7 shows a brake frame of the towing winch system.

Identical reference signs are used in the drawings to indicate identical or functionally similar components. In this description, vertical and horizontal are referred to as planes or directions in their ordinary meaning. Directions related to the vessel or towboat defined by horizontally or vertically are taken when the vessel or boat is in a position afloat, in a normal, stabilised position.

FIG. 1 and FIG. 2 show in perspective views a towing winch system 1 according to the invention. FIG. 3 shows an exploded view of the towing winch system and FIGS. 4-6 show respectively a frontal, top and side view of the towing winch system. The towing winch system is configured for carrying out a towing operation, in particular an escort operation.

In comparison with other operations, like anchoring and mooring, towing operations are typically carried out with relative long horizontally extending towlines. In an escort operation, typically, a towline of at least 100 meters is arranged in between a towboat and a floating object, e.g. a tanker or a vessel. The towboat is manoeuvring to guide the vessel along a predetermined trajectory. During these escort operations, to prevent slack, the towline should be kept under tension. On the one hand, to prevent a breakage of the towline, the tension may not exceed a certain value. Attention should be paid in that high tensions may occur abruptly, and the towing winch system should respond accordingly. On the other hand, to prevent slack, the towline may not hang loose in between the floating object and the towboat. In such a situation, the towing winch system should wind the towline at high speeds. Hence, to perform in escort operations, the towing winch system 1 is required to resist high occurring peak loads of for example 100 to 300 tonnes and at the same time the towing winch system is required to respond with high rotational speeds in both directions to compensate large towline lengths when slacking occurs.

The towing winch system 1 according to the invention is configured to perform under these heavy circumstances occurring in a towing operation. The towing winch system 1 comprises a framework 2 for holding a winding drum 3, a drive 4, a brake 5 and a gear 7. A control unit 6 is provided to control the towing winch system.

In the illustrated embodiment of FIG. 1-6, the winding drum 3 is positioned in between the drive 4 and the brake 5. Alternatively, the drive and brake may both be positioned at one end of the winding drum.

The drive 4 is connected by the gear 7 to the winding drum 3 for accelerating the winding drum. The brake 5 comprises a brake disc 50 which is connected to the winding drum 3 and a plurality of brake calipers 51 to engage the brake disc 50, which brake calipers 51 are connected to the framework 2, such that the winding drum 3 can be decelerated by the brake 5. The drive 4 and the brake 5 are operatively connected to the control unit 6. The control unit 6 is programmed to control the rotation of the winding drum 3 by controlling the drive 4 and the brake 5. The plurality of brake calipers 51 is beneficial in controlling the deceleration of the winding drum by allowing one or more brake calipers 51 to engage the brake disc. By varying the amount of active brake calipers 51, the winding drum 3 can be decelerated in dependence of occurring circumstances during an escort operation.

The drive 4 driving the winding drum 3 is an electrical drive. Here, the drive 4 is fully electric. The drive 4 comprises a plurality of brushless alternating current motors 40. Each motor 40 has its own motor housing 41 and motor output shaft 42. The plurality of electric motors 40 is beneficial, because by activating a selection of one or more motors, the towing winch system is configured to anticipate on different situations occurring during an escort operation.

The motor 40 is a brushless AC motor, also called a permanent magnet synchronous motor PMSM. The motor has a motor rotor provided with permanent magnets to provide a magnetic field. The motor rotor is carrying an amount of permanent magnets. Preferably, the permanent magnets are equally spaced in a circular array at an outer circumferential surface of the motor rotor. The permanent magnets define an amount of motor poles of the motor. In particular, the motor rotor has at least 8 motor poles. Preferably, the motor rotor has at least 16 motor poles. A large amount of motor poles may be beneficial to obtain a substantially constant driving torque. Advantageously, the at least 16 motor poles contribute in providing a high-torque which remains available over a wide range of rotating speeds of the winding drum.

Preferably, the permanent magnets contain neodymium. Preferably, the permanent magnets are Neodymium-Iron-Boron magnets. Advantageously, a neodymium containing magnet contributes to a more powerful motor.

The motor 40 has a motor housing for housing a plurality of field coils. The motor rotor is driveable by the plurality of field coils. The field coils form a motor stator. The field coils are preferably situated around a circumference of the motor rotor. The amount of field coils corresponds with the amount of motor poles.

FIG. 3 shows the towing winch system 1 of FIG. 1 in an exploded view. The towing winch system has a framework 2 which is mountable to a deck of a towboat. The framework 2 is arranged for housing winch components of the towing winch system 1. Here, the framework 2 has a modular configuration. The framework 2 is assembled by a mainframe 20, a brake frame 21 and a drum frame 22.

The mainframe 20 is block-shaped and assembled by a bottom plate 200, a left and right side plate 220, a front plate 230 and a back plate 240. The plates forming the mainframe 20 provide an inner space for receiving the winch components.

The mainframe 20 further comprises a base plate 250. The mainframe 20 is pivotally connected to the base plate 250. The mainframe 20 is pivotable with respect to the base plate 215 about a pivot axis 251. The pivot axis A-A extends in a horizontal direction transversal the mainframe 20. The pivot axis extends from the left to the right side plate 220. At least one load sensor 60 is positioned in between the bottom plate 200 and the base plate 250 for measuring a load during a towing operation. The at least one load sensor 60 is positioned at a distance from the pivot axis A-A. During a towing operation, tension forces on the towline will exert a torque on the drum 30 which will be deducted by the brake 5 to the framework 2 and measured by the at least one load sensor 60. Here, the pivot axis 251 comprises a pivot shaft which is mounted at a back region of the mainframe 20. Here, as shown in FIG. 4, two load sensors 60 are mounted at a front region of the mainframe 20. At least two load sensors are beneficial to obtain multidirectional load data.

Each side plate 220 is provided with a winch shaft support 221 for supporting a drum shaft 33. Here, the drum shaft 33 is arranged stationary. The drum 30 is rotatable with respect to the drum shaft 33. A left and right winch shaft lock 222 are provided to clamp the drum shaft 33 to the winch shaft supports 221 of the side plates 220 of the mainframe 20.

The winding drum 3 is arranged for winding and unwinding a towline. The winding drum comprises a drum 30 which has a winding zone 320 in between a first and second drum flange 31, 32. Here, at least one of the first and second drum flanges 31, 32 is provided with a visual winding indicator to indicate a predetermined winding area. Preferably, the visual winding indicator of a drum flange 31, 32 is provided by a two-colour indicator consisting of two visually distinct colours, e.g. a black and yellow colour. The yellow colour at a bottom region of the winding zone may indicate a sub-area of the winding zone which should always remain wound during operation. The drum 30 is supported by a drum bearing 34 which is mounted to the drum 30. The drum shaft 33 is supported by the framework 2 at a first and second winch shaft support 221.

FIG. 3 further shows the gear, which gear 7 is a one-stage gear. The gear 7 provides a direct drive of the winding drum 3. The gear 7 provides a one-step reduction of an applied rotational speed of the motor output shaft 42 to a rotational speed of the winding drum 3. The gear 7 provides a gear ratio of at least 15:1 in one stage.

The gear 7 comprises a gear wheel 70 which is fixed to the first drum flange 31. The gear wheel 70 and the connected winding drum 3 is driveable by engaging motor gear wheels 71. Each motor gear wheel 71 is directly mounted to a motor output shaft 42 of a motor 40. The gear wheel 70 may have a toothed inner surface to be engaged. Preferably, the gear wheel 70 has a toothed outer surface, wherein the motor gear wheels 71 engage from the outside onto the gear wheel 70. Advantageously, the arrangement of the gear wheels 71 outside the gear wheel 70 allow a quick removal of the gear wheel in maintenance, while keeping the motors 40 mounted to the side plate 220.

In addition, the motors 40 are positioned in an arch shaped array. Preferably, the arch shaped array does not extend outside a lower half of a circular array which is beneficial in maintenance of the towing winch system in allowing the winding drum 3 to be lifted from the winch shaft support 221 without any need for demounting any of the motors 40.

As shown in FIG. 3, here, a motor plate 49 is provided for mounting a motor 42 to a side plate 220, also called motor side plate, of the framework 2. The motor plate 49 may be integral with or separately connectable to the motor housing 41 of the motor 40. The motor plate 49 allows a quick and easy adjustable mounting of the motor 40 to the motor side plate 220.

The motor side plate 220 comprises a plurality of motor apertures which each provide a through for each motor output shaft 42 of each mounted motor 40. The motor 40 is mountable to the motor aperture by its motor plate 49. As seen above, each motor output shaft 42 is provided with a motor gear wheel 71. After assembly, the motor gear wheel 71 is positioned in the inner space of the mainframe 20 inside a gear compartment 27. The gear compartment 27 is configured for housing the gear wheel 70 of the gear 7. The gear compartment 27 is covered by a gear cover 79 to enclose the gear wheel 70.

As shown in FIG. 1-6, the brake 5 is positioned with respect to the drive 4 at an opposite side of the winding drum 3. The brake disc 50 is fixed to the second drum flange 32 of the winding drum 3.

In operation, the brake disc 50 rotates together with the winding drum 3. Brake calipers 51 are positioned at a circumference of the brake disc 50. Each brake caliper 51 is provided with a pair of brake pads 52 to engage the flat end surfaces of the brake disc 50. Preferably, the brake calipers 51 are positioned in a similar way as the motors 40 which is beneficial in servicing the towing winch system. The brake calipers 51 are positioned in an arch shaped array. Preferably, the arch shaped array is bounded within a lower half of a circular array to allow an upwards removal of the brake disc 50 during maintenance, while keeping the brake calipers 51 mounted at their position.

FIG. 7 shows a subassembly of the brake frame 21 and brake calipers 51 in a separate view. The plurality of brake calipers 51 is mounted to the brake frame 21. The brake frame 21 is U-shaped. The U-shaped brake frame 21 comprises an inner mounting surface for mounting the plurality of brake calipers 51. The U-shaped brake frame 21 has upstanding U-legs 210 interconnected by an U-bridge portion 211. The U-legs form an in between space for receiving the brake disc 50. The brake disc 50 can be lowered into the space, such that the brake disc 50 is engageable by each brake caliper 51.

One of the U-legs 210 is provided with a distributor 53 for hydraulically connecting the plurality of brake calipers 51. The distributor 53 provides a central hydraulic connector for controlling the plurality of brake calipers 51. The releasable subassembly of the brake frame 21 is beneficial in servicing the towing winch system.

As shown in FIG. 7, in an alternative embodiment, the brake frame 21 may be provided with a load sensor 60. The load sensor 60 is configured to measure a deformation of the brake frame 21. In operation, the deformation is caused by tension forces exerted by the towline on the winding drum 3. The measured deformation is indicative of a torque acting on the winding drum 3 and transferred to the brake frame 21 via the drum 30, the connected brake disc 50 and the engaging brake calipers 51. Preferably, the load sensor 60 is positioned at a lower region, in particular at a corner position, of the U-shaped brake frame 21.

Numerous variants are possible in addition to the embodiment shown in the figures. In a variant of the illustrated embodiment of the drum in between the drive and brake, in an alternative embodiment, the drive and brake may be both positioned at one side of the drum. In an alternative embodiment, the brake may comprise more than one brake disc which may each in engagement with a group of brake calipers.

Although the present invention has been described in detail, it will be apparent to those skilled in the art that various changes and modifications can be made without departing from the scope of the invention as hereinafter claimed. It is intended that all such changes and modifications be encompassed within the scope of the present disclosure and claims.

Thus, the invention provides a towing winch system for controlling a render and recovery of a towline during a towing operation. The towing winch system has a control unit for controlling a drive and a brake for respectively driving and braking the winding drum. In a first aspect, the drive comprises a plurality of brushless alternating current motors which each engages in one stage by a motor gear wheel to a gear wheel mounted to the winding drum. The brake comprises a plurality of brake calipers which each are engageable to a brake disc mounted to the winding drum. The drivetrain of the plurality of brushless AC motors, one stage gear and the plurality of brake calipers form a powerful and robust structure to operate the towing winch system 1 under severe conditions which may occur in a towing operation.

Reference signs list:

| | |
|---|---|
| 1 | towing winch system |
| 2 | framework |
| 3 | winding drum |
| 4 | drive |
| 5 | brake |
| 6 | control unit |
| 7 | gear |
| 20 | main frame |
| 200 | bottom plate |
| 220 | side plate |
| 221 | winch shaft support |
| 222 | winch shaft lock |
| 230 | front plate |
| 231 | towline aperture |
| 240 | back plate |
| 250 | base plate |
| 251 | pivot axis A-A |
| 21 | brake frame |
| 210 | U-leg |
| 211 | U-bridge portion |
| 22 | drum frame |
| 27 | gear compartment |
| 30 | drum |
| 31 | first drum flange |
| 32 | second drum flange |
| 320 | winding zone |
| 33 | drum shaft |
| 34 | drum bearing |
| 40 | motor |
| 41 | motor housing |
| 42 | motor output shaft |
| 49 | motor plate |
| 50 | brake disc |
| 51 | brake caliper |
| 52 | brake pad |
| 53 | distributor |
| 60 | load sensor |
| 70 | gear wheel |
| 71 | motor gear wheel |
| 79 | gear cover |

1-18. (canceled)

19. A towing winch system configured to control a render and recovery of a towline in between a vessel and a towboat during a towing operation, in particular an escort operation, which towing winch system comprises:
a framework for supporting winch components;
a winding drum for winding and unwinding the towline in which the winding drum is rotatable supported by the framework, in which the winding drum has a drum forming a winding space in between a first and second winding drum flange for enclosing the towline;
a drive directly connected by a one-stage gear to the winding drum for rotating the winding drum for hauling in the towline, wherein the one-stage gear comprises a gear wheel mounted to the winding drum;
a brake connected to the winding drum for braking the winding drum for holding or paying out the towline, wherein the winding drum is positioned in between the drive and the brake, wherein the brake disc is mounted to one of the drum flanges and the gear wheel is mounted to the other one of the drum flanges; and
a control unit for controlling the drive and the brake based on an input signal indicative of a torque exerted by the towline on the winding drum;
wherein the drive comprises a plurality of brushless alternating current motors, wherein each motor has a motor housing and a motor output shaft provided with a motor gear wheel which engages to the gear wheel mounted to the winding drum,
wherein the brake comprises at least one brake disc and a plurality of brake calipers in which each brake caliper is provided with a pair of brake pads for engaging the at least one brake disc, wherein the plurality of motor gear wheels and the plurality of brake calipers are all positioned in a lower half region of the gear wheel such that the gear wheel can be lifted from the framework without demounting the motors, wherein the framework comprises a mainframe and a brake frame being arranged for supporting the plurality of brake calipers, and wherein the brake frame is releasably connectable to the mainframe.

20. A render and recovery winch system for controlling a render and recovery of a towline in between a vessel and a towboat during a towing operation, in particular an escort operation, which render and recovery winch system comprises:
a framework for supporting winch components;
a winding drum for winding and unwinding the towline in which the winding drum is rotatable supported by the framework, in which the winding drum has a drum forming a winding space in between a first and second winding drum flange for enclosing the towline;
a drive connected by a one-stage gear to the winding drum for rotating the winding drum for hauling in the towline, wherein the one-stage gear comprises a gear wheel mounted to the winding drum;
a brake connected to the winding drum for braking the winding drum for holding or paying out the towline; and
a control unit for controlling the drive and the brake based on an input signal indicative of a torque exerted by the towline on the winding drum;
wherein the drive comprises a plurality of brushless alternating current motors, wherein each motor has a motor housing and a motor output shaft provided with a motor gear wheel which engages to the gear wheel mounted to the winding drum, and
wherein the brake comprises at least one brake disc and a plurality of brake calipers in which each brake caliper is provided with a pair of brake pads for engaging the at least one brake disc.

21. The render and recovery winch system according to claim 20, wherein the motor has a motor rotor provided with at least 8 permanent magnets.

22. The render and recovery winch system according to claim 20, wherein the drum is rotatable supported by a horizontally arranged drum shaft, wherein the winding drum shaft is supported by the framework.

23. The render and recovery winch system according to claim 22, wherein the drum shaft is arranged stationary.

24. The render and recovery winch system according to claim 20, wherein the gear wheel is mounted to the drum, in particular to one of the drum flanges of the drum.

25. The render and recovery winch system according to claim 20, wherein each motor gear wheel engages to an outer toothed circumferential surface of the gear wheel.

26. The render and recovery winch system according to claim 20, wherein the brake frame is L-shaped, more in particular U-shaped, comprising an inner mounting surface for positioning the plurality of brake calipers, such that the brake calipers are positioned at an outer circumference of the brake disc of the render and recovery winch system.

27. The render and recovery winch system according to claim 20, wherein the framework, in particular the brake frame, comprises at least one load sensor for measuring a force inducted by a brake caliper.

28. The render and recovery winch system according to claim 27, wherein the mainframe comprises a base plate, wherein an upper portion of the mainframe is pivotally connected to the base plate about a pivot axis, wherein the at least one load sensor, in particular two load sensors, is positioned in between the upper portion and the base plate at a distance from the pivot axis.

29. The render and recovery winch system according to claim 20, wherein at least one of the drum flanges has a coding, in particular a colour coding for visually indicating a winding zone of the winding space.

30. A towboat for towing a floating object, in particular an escort tug for escorting a vessel, comprising a render and recovery winch system according to claim 20.

31. An assembly of a towboat according to claim 30 and a floating object interconnected by a towline.

32. A method for towing a floating object by a towboat, in particular an escort method for assisting a vessel by a towboat in passing a water passage, wherein use is made of a render and recovery or towing winch system according to claim 20, wherein the method comprises steps of:
interconnecting the floating object, in particular the vessel to be escorted and the towboat, in particular an escort tug, by a towline;
measuring an occurring torque exerted by the towline on a winding drum of the render and recovery winch system;
controlling a drive of the render and recovery winch system to rotate the winding drum for hauling in the towline; and
controlling a brake of the render and recovery winch system to brake the winding drum for holding or paying out the towline.

33. The method according to claim 32, wherein only a portion of a plurality of brake calipers and/or motors is activated to respectively brake or drive the winding drum.

34. The method according to claim 32, wherein the towing method is an escort method for escorting a vessel by the towboat.
